(19) United States
(12) Patent Application Publication
(10) Pub. No.: US 2008/0109489 A1
(43) Pub. Date: May 8, 2008

(54) Method For Generating Reports

(76) Inventor: Adrian Sherwood, Texas City, TX (US)

Correspondence Address: MARK L. COOPER ESQ, 2200 MARKET STREET, SUITE 325, GALVESTON, TX, 77550, US

(21) Appl. No.: 11/933,957

(22) Filed: Nov. 1, 2007

Related U.S. Application Data
(60) Provisional application No. 60/864,326, filed on Nov. 3, 2006.

(51) Int. Cl. G06F 17/30

(52) U.S. Cl. 707/104.1; 707/E17.009

(57) ABSTRACT

Disclosed herein is a method of generating a report comprises a contacting step, a receiving step, an input string storing step, a reviewing of the input string step, a combining step, a report storing step, and a report delivering step.

### RELATED APPLICATIONS

This application is a non-provisional utility application which claims benefit of co-pending U.S. Patent Application Ser. No. 60/864,326 filed Nov. 3, 2006, entitled “METHOD FOR GENERATING REPORTS” which is hereby incorporated by reference.

### BACKGROUND OF THE INVENTION

The present invention generally relates to apparatus and method for generating and distributing reports. In particular, generating and distributing multi-media reports relating to professional services.

Various professional services require providing pertinent information to clients concerning prospective opportunities of interest. Such information is often specific to a particular client's needs and desires. Professionals must understand the client's needs and wants, and then produce detail specific reports for their clients. Such activities are both labor and time intensive, and require information that may only be available in the conscience of the professional servicing the account.

As can be seen, there is a need for an expedited process wherein reports containing client and project specific information may be prepared and distributed with minimal expenditure of time on the part of the professional.

### SUMMARY OF THE INVENTION

In one aspect of the present invention a method of generating a report comprises the steps of:

a) a user contacting an input receiving system;

b) the input receiving system receiving an input string from the user, wherein the input string comprises one or more pre-determined trigger words, trigger phrases, and/or trigger text;

c) the input receiving system storing the input string for future retrieval;

d) retrieving of the stored input string by a reviewing system;

e) reviewing of the stored input string by the reviewing system, wherein each of the trigger words, trigger phrases, and/or trigger text are each recognized by the reviewing system and are each associated with one or more pre-recorded audio files, image files, text files, and/or video files by the reviewing system;

f) combining the one or more associated pre-recorded audio files, image files, text files, and/or video files into a report; and

g) storing of the report for later retrieval.

These and other features, aspects and advantages of the present invention will become better understood with reference to the following drawings, description and claims.

### BRIEF DESCRIPTION OF THE DRAWINGS

FIG. 1 is a block diagram of the steps of an embodiment of the instant method;

FIG. 2 is a block diagram showing an embodiment of the Receiving Step of the instant method;

FIG. 3 is a block diagram showing an embodiment of the Reviewing and Combining Steps of the instant method;

FIG. 4 is a block diagram showing an embodiment of the Report Delivery Step of the instant method;

FIG. 5 is an embodiment of a text based input string;

FIG. 6 is an embodiment of a web-based input string;

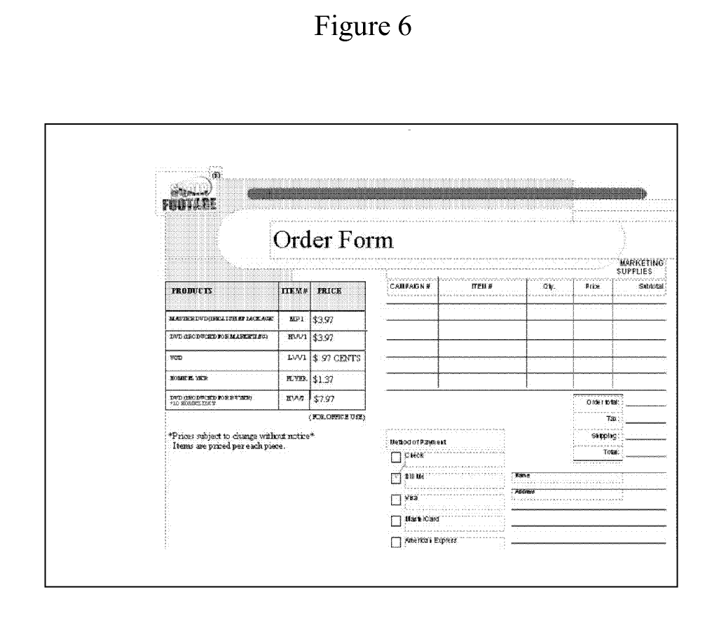

FIG. 7 is a block diagram showing an embodiment of the Receiving step; and

FIG. 8 is an embodiment of a web-based application for receiving an input string.

The figures represent preferred embodiments of the instant method, and are not intended to be, nor are to be construed as limiting the scope of the instant disclosure, which is best determined according to the recitation of the appended claims.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention generally provides a method of generating a report. The method includes the steps of a user contacting an input receiving system; the input receiving system receives an input string from the user. The input string supplied by the user preferably comprises one or more pre-determined trigger words, trigger phrases, and/or trigger text, which are recognizable by the input receiving system. The input receiving system preferably stores the input string for future retrieval. The stored input string is then retrieved by a reviewing system. The input string is then reviewed by the reviewing system, wherein each of the trigger words, trigger phrases, and/or trigger text are each individually recognized by the reviewing system, and actions are taken based on these trigger words, trigger phrases, and/or trigger text such that each are associated with one or more pre-recorded audio files, image files, text files, and/or video files by the reviewing system. These associated pre-recorded audio files, image files, text files, and/or video files are then combined into a report. The report is then preferably stored for later retrieval.

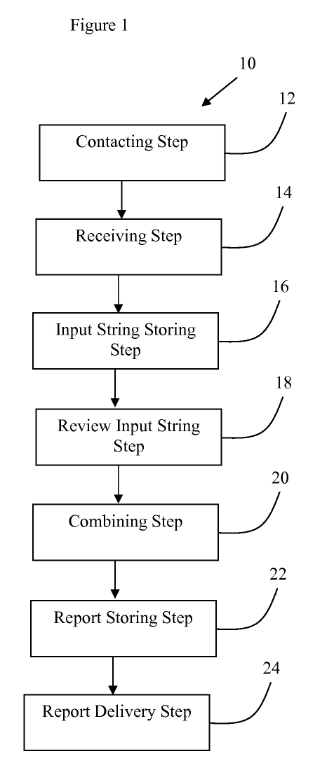

As shown in the block diagram of FIG. 1, in an embodiment, the report generation method generally represented as (10) comprises a contacting step (12), wherein the user initiates contact with an input receiving system. In an embodiment, the contact may be in the form of a telephone call, a facsimile transmission, an email, a web based form, or by any appropriate method depending on the limitations of the input receiving system. Accordingly, the input receiving system may comprise a voice mail system, wherein an input string in the form of a telephonic message is received and stored for subsequent use. In another embodiment, the input receiving system may comprise an internet web-based application (e.g., a web page), wherein the input string offered by the user is input into appropriate fields and attachments of the web-based application. In another embodiment, the input receiving system may comprise a facsimile based system utilizing appropriate soft ware and methods capable of deciphering the input string offered by the user. In yet another embodiment, the input receiving system may comprise a human being which records the input stream offered by the user onto one or more forms utilized for such a purpose.

The contacting step (12) is preferably followed by a receiving step (14), wherein the input receiving system receives an input string from the user followed by an input string storing step (16), wherein the input string offered by the user and received by the input receiving system is stored for future retrieval and use in preparing the intended report or reports.

The input string preferably comprises instructions related to the content of the report to be produced. In an embodiment, the input string comprises one or more predetermined trigger words, trigger phrases, and/or trigger text, depending on the form and type of input receiving system utilized. These triggers have a pre-determined meaning prior to the contacting step (12) such that each represents an action to be used as instructions in producing the report. Examples of suitable triggers for use herein include words, phrases, and/or text which specify one or more of a user identification, a client identification, a project identification, an industry specific identifier, and the like. In addition, the triggers may include actions to be undertaken by a reviewing system. The method (10) may further comprise the step of authenticating the user as being an authorized user. This may be accomplished using a user ID number or code, and/or a personal identification number or code assigned to each account.

The method (10) further comprises a reviewing input string step (18), wherein the stored input string is retrieved and reviewed by a reviewing system. The review of the input string includes the process of reviewing the input string, wherein each of the trigger words, trigger phrases, and/or trigger text are each recognized by the reviewing system and are each associated with one or more pre-recorded audio files, image files, text files, and/or video files by the reviewing system.

The method (10) further comprises a combining step (20), wherein the one or more associated pre-recorded audio files, image files, text files, and/or video files are combined and preferably arranged into a report.

The method (10) further comprises a report storing step (22), wherein the report generated in the combining step (20) is stored for later retrieval.

In an embodiment, the method (10) may further comprise a report delivering step (24), wherein the report generated by the method (10) is delivered to at least one intended recipient.

In an embodiment, the reviewing system may comprise a computer with the associated memory and processor running software capable of recognizing the triggers, either in spoken form and/or in text form, depending on how the input string is provided to the input system. In an embodiment, the review system may include human intervention, wherein the triggers and the associated date contained in the input string is recognized and manipulated in concert with the pre-determined meanings of the triggers.

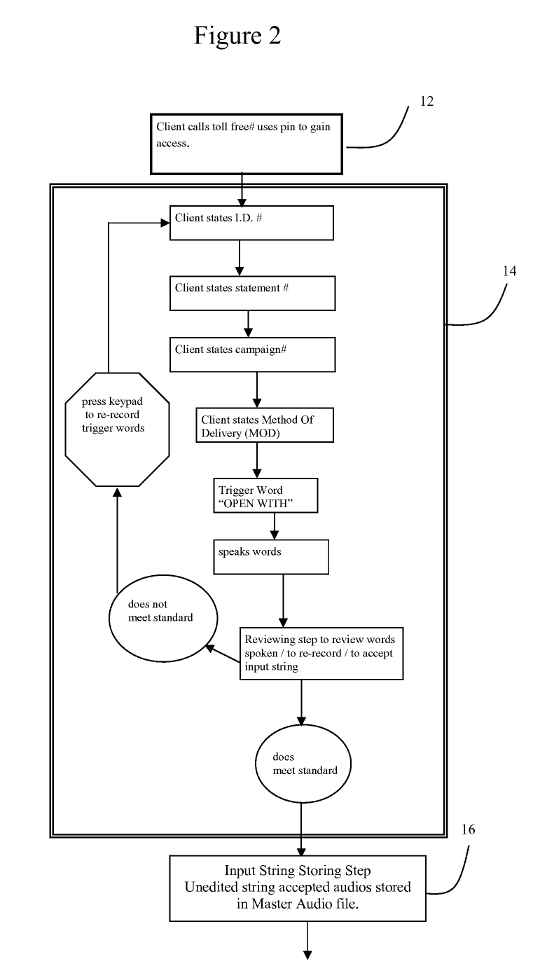

Turning now to the embodiment shown in FIG. 2, Contacting Step (12) may include a client calling a toll free telephone number and entering a personal identification number (pin) to gain access to the system. Receiving step 14 may include an input string comprising a Client ID number, a client statement number, a client campaign number, a client method of delivery (MOD) statement, and/or recorded input e.g., signaled via the trigger word “OPEN WITH”. Contacting Step (12) may further include a reviewing step, wherein the client is able to review and/or re-record his spoken words. Once the client confirms the input string meets her standards, the input string may then be stored in the Input String Storing Step (16).

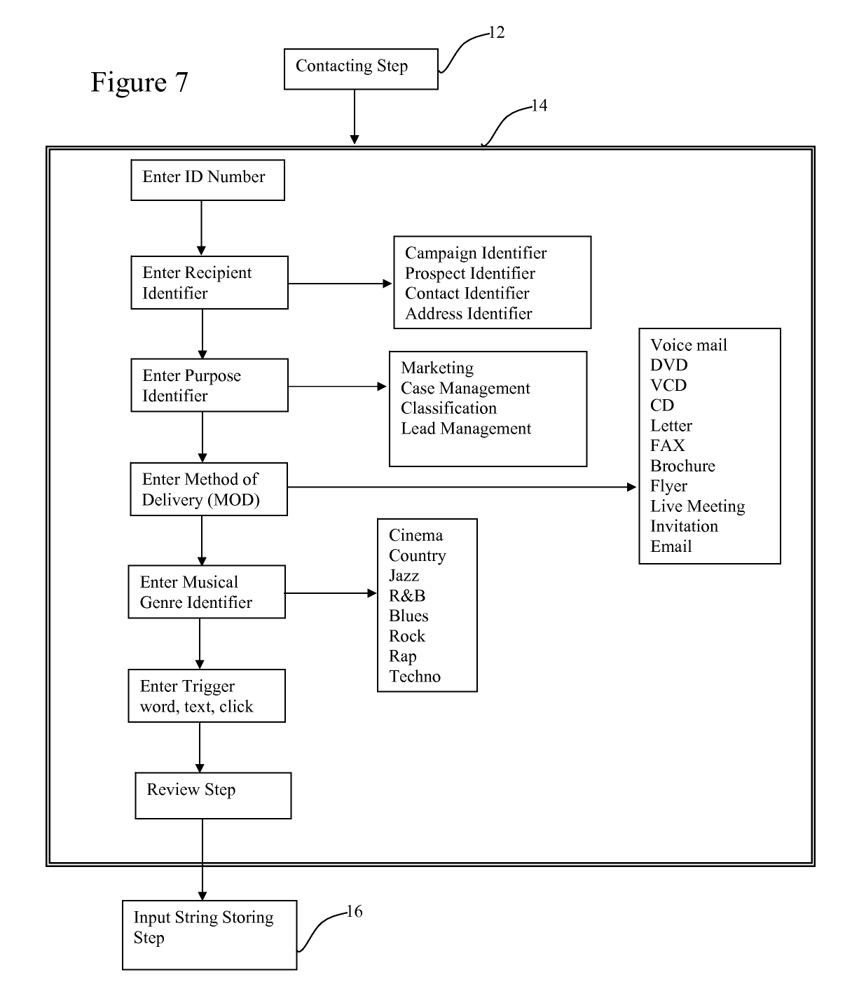

As shown in FIG. 7, Receiving step 14 may include the entering, via the spoken word, telephone key pad, text, HTML, or the like, of any one of the following:

an ID Number;

a Recipient Identifier, which may include, for example, a Campaign Identifier, a Prospect Identifier, a Contact Identifier, and/or an Address Identifier;

a Purpose Identifier, which may include, for example, a Marketing identifier, a Case Management identifier, a Classification, and/or a Lead Management identifier;

a Method of Delivery (MOD), which may include, for example, Voice mail, DVD, VCD, CD, Letter, FAX, Brochure, Flyer, Live Meeting, Invitation, and/or Email; and

a Musical Genre Identifier, which may include, for example, Cinema, Country, Jazz, R&B, Blues, Rock, Rap, and/or Techno.

This input string may be followed by entering of a trigger word, text, or appropriate selection of a URL in a web page wherein the client may enter in further information of the report. These steps may then be followed by a reviewing step and then Input String Storing Step 16.

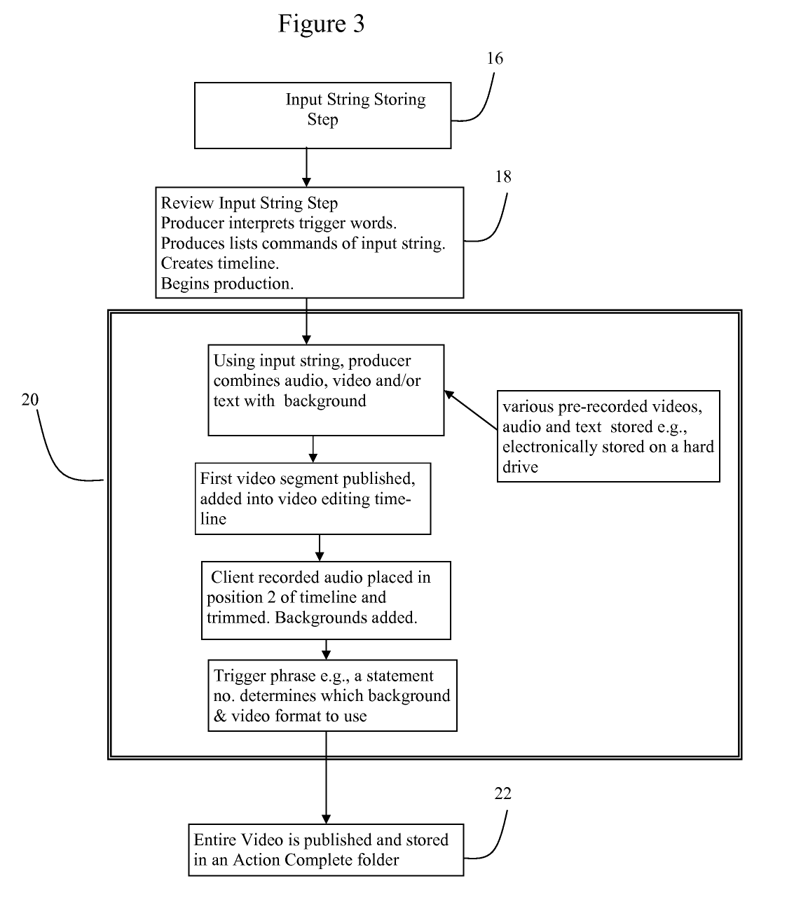

As shown in FIG. 3, the Input String Storing Step (16) may then be followed by the Review Input String Step (18), wherein a producer (e.g., a human being, a computer running software, or a combination thereof, may review the input string and produce a listing of the commands of an input string.

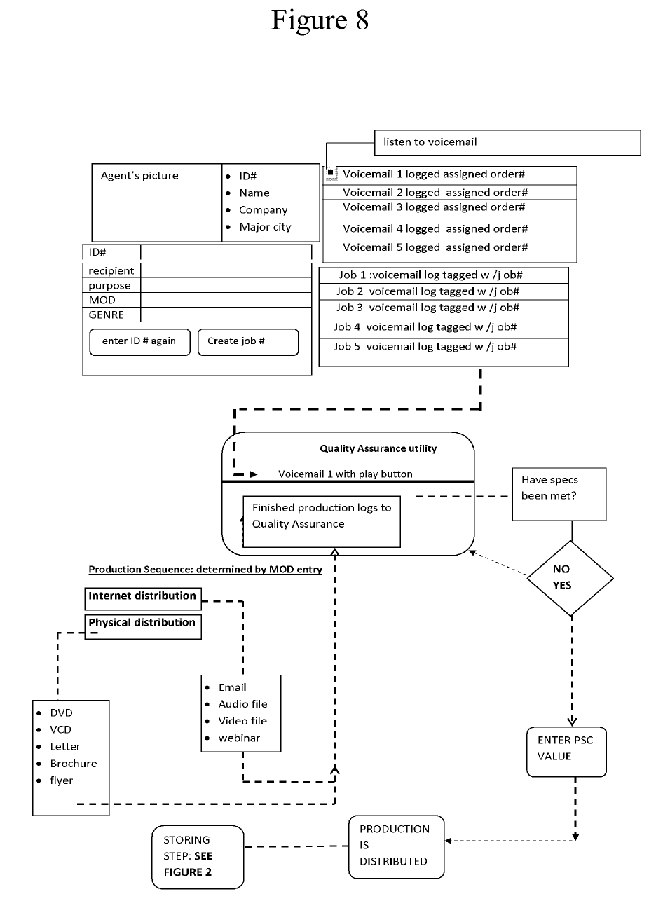

In and embodiment, Review Input String Step 18, the Combining step 20, the Report Storing Step 22, and the Report Delivery Step 24 may include one or more web based applications/web pages allowing a reviewer to review the various facets of the input string, associate the facets of the input string with pre-determined and/or pre-recorded presentations, and/or organize the facets of the input string into a report, store the report, and delivery the report. An example of a web based application which may be utilized by the reviewer is shown in FIG. 8.

From this listing, a timeline for the report is generated and the report is then produced according to Combining Step (20). In Combining Step (20) the input string is utilized by the producer to trigger and arrange the combination of audio, video and/or text with a background. The various inputs may be pre-recorded and indexed portions of the report, and/or the clients own recorded input from the previous Receiving Step (14) may be included in the report. Once the report is finalized, which may include a final review step, the report is stored in the Report Storing Step (22), which may include storing of a video in an action complete folder, or the like.

In an embodiment, the instant method may include one or more quality control step(s), which may occur at any point prior to Report Delivery Step 24. The method may further comprises one or more quality control steps, wherein the quality of the report being generated is reviewed and passed on for further processing or returned to a previous step for modification, prior to the storing of the report for later retrieval. In an embodiment, method (10) may include the step of delivering the report electronically by transmitting the report over a network to the at least one intended recipient. The step of delivering the report may include delivery of the report via a telephonic audio delivery, an e-mail, a facsimile transmission, or a combination thereof.

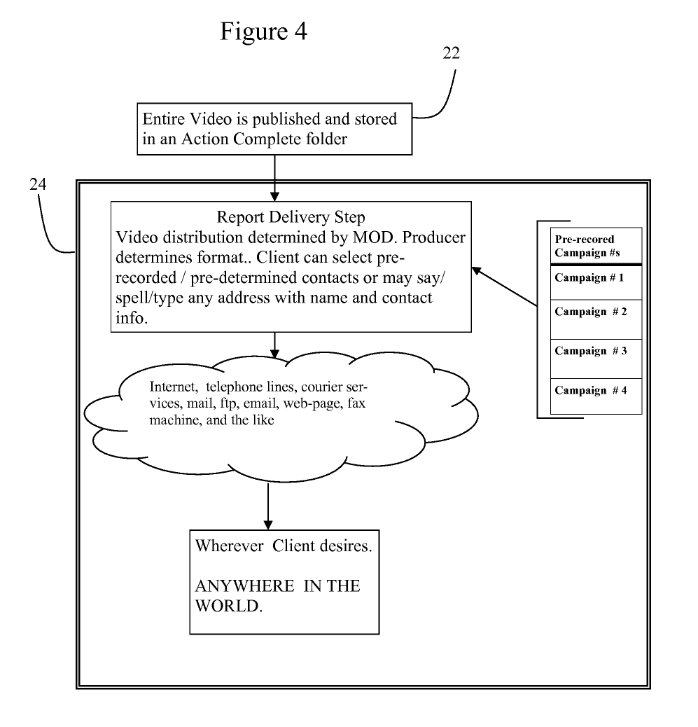

Accordingly, the Report Generation Method (10) may further comprise a Report Delivery Step (24), wherein a published report stored as part of a Report Storing Step (22) is distributed via various means to intended recipients. In the embodiment shown in FIG. 4, Report Delivery Step 24 may include video distribution determined according to the method of delivery (MOD) specified in Receiving Step (14), and/or may be specified in the input string by pre-determined campaign number, and/or by entering in the actual information during Receiving Step (14). The internet, telephone lines, courier services, mail ftp, email, web-page, fax machine or the like may then be utilized to deliver the report or reports and any specified client or clients anywhere in the world, as specified by the client.

In an embodiment, the step of delivering the report may include the step of recording the report onto portable media such as in print, on a CD, a DVD, a solid state memory device, or any such device which may store analogue and/or digital information for later retrieval, and physically distributing the portable media to an intended recipient, e.g., via mail, courier, and/or the like.

In an embodiment, the input string comprising one or more pre-determined trigger words, trigger phrases, and/or trigger text may further include one or more trigger words, trigger phrases, and/or trigger text in which an audio file, an image file, a text file, and/or a video file is recorded as part of the input string, to produce one or more of the pre-recorded audio files, image files, text files, and/or video files which then may be incorporated into the report. Accordingly, the input string may comprise data which may then be utilized to produce one or more pre-recorded audio files, image files, text files, and/or video files, which may then be stored for subsequent retrieval and/or use in preparing the report. In a preferred embodiment, the input string of one or more pre-determined trigger words, trigger phrases, and/or trigger text includes one or more trigger words, trigger phrases, and/or trigger text comprising a project identifier input, which identifies a particular project. The input string may also comprise a trigger to include a pre-recorded opening statement, closing statement, or a combination thereof.

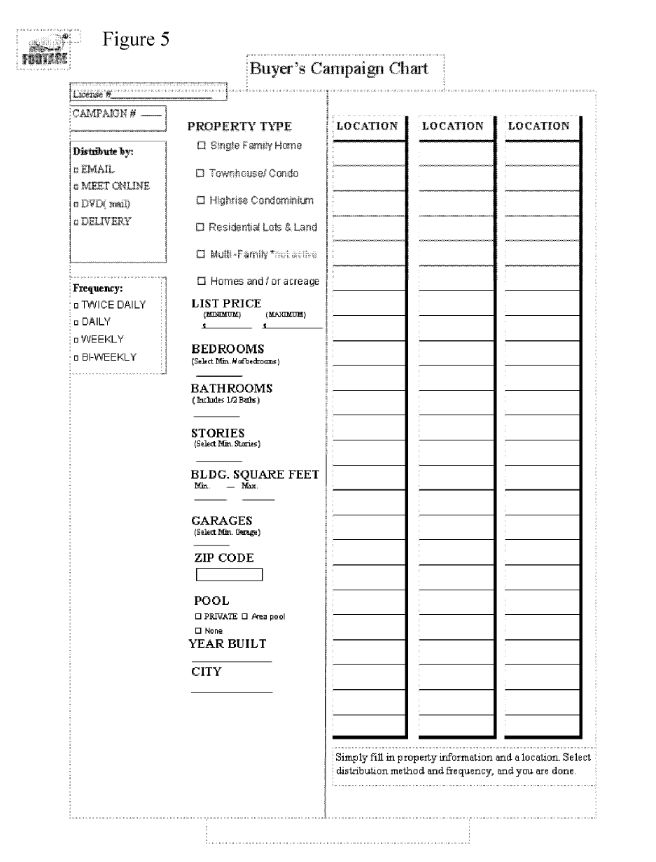

As shown in FIG. 5, the input string may include a form which may be filled out in paper form by a client and mailed, faxed, emailed, and the like, or may be filled out as an online form e.g., via a web page to be then stored in the Input String Storing Step (16). Examples of trigger words and phrases which may be used according to the method described herein include:

I.D. #=IDENTIFIES THE CALLER

STATEMENT #=Unique number used to identify a unique script. Script used to produce a video.

CAMPAIGN #=Unique number assigned to a particular person or product or a combination thereof.

MOD=stands for ‘Method of Distribution’; allows caller to select a preferred type of communications medium (email, DVD, VCD, online conferencing) for a particular ‘ACTION’

OPEN WITH=Pinpoints an audio trim point.

LOOP IT=signals a new ‘ACTION’ sequence. caller starts at statement # and completes a new set of trigger words

DESTINATION #=A unique number assigned to a particular location.

GENRE STYLE=refers to a particular genre of music (R&B, country, classical etc.)

In an embodiment, method may further include a step of monitoring a previously produced report or group of related reports until a client provides an input terminating such monitoring. The input terminating the monitoring of a report or group of related reports may further include an input indicating the outcome of a particular project. For example, in the case of real estate, a report describing a home for sale may be terminated by a client, e.g., a realtor, with an indication that a sale was made of the home which was included in the report, to an intended designee of the report.

The input string may be entered via a web based application. The input string received by one or more of the web-based applications may include text, check boxes, audio, video, universal resource locators, or a combination thereof. The web based application may include one or more of the following utilities which may, in turn, be utilized by the method to generate, and/or monitor the report. Utilities include a:

Campaign Management Entry page, Client Manager, Seller Campaign Manager, Buyer Campaign Manager, Client/Campaign Reactivation Manager, Training Module viewer, Profile Editor form, Non-Subscription Order form, Contact Manager form, Subscription Order form, Music/Video viewer, Asset viewer, Chart viewer, Statement viewer, Order Management Related, MOD Order Viewer, Customer Service Thread System sample age (agent version), Calendar System, Campaign tab, Prospect tab, Contact tab, Physical Order Viewer, Vendor Selector, Affiliate Selector, Action Folder Manager sample page, Prospect Manager, Class Recommendation Utility, Asset Design Scheduler, MOD Quality Assurance Manager, Campaign Level Billing History viewer, Integrated Dashboard, Campaigns tab, Clients tab, Prospects tab, Pending Agent Manager, Home Picture Viewer, Music Upload Manager, Video Upload Manager, Training Upload Manager, Asset Class Manager (upgraded to enhanced specs in OMS plan), Chart Manager (upgraded to enhanced specs in OMS plan, if any), Statement Manager (upgraded to enhanced specs in OMS plan), Subscription Manager, Product Manager, Mileage Based Billing Manager, Time Based Billing Manager, Quantity Threshold Pricing Manager, MOD Quality Assurance Manager, MOD Production Time Tracking Manager, A/V MOD Link Manager, MOD Utilization Tracking Manager, Picture Upload Manager, Agent PIN Number (sample selector control and data popup), Customer Service Thread System sample age (admin version), Physical Order Manager, Vendor Manager, Affiliate Manager, MOD Links Manager, MOD Generator Utility, MOD Status Utility, Agent Locator Utility, Special Force Manager, Payment Exceptions Manager, Free Trial Manager, Poor Performance Manager, Promotion Manager, and/or Permission Manager.

### EXAMPLES

Exemplary operation of the instant method of generating a report includes the following:

A report may be generated to assist a professional in marketing a specific product or item. For example, a project number may be assigned to a specific set of activities (e.g., in a Real Estate market a case or a campaign number may be assigned) to identify the particular product.

### Example 1

A user (e.g., a Realtor) has three different homes or “listings” under contract:

1421 Meadow Dr.—assigned campaign #1;

2230 Ocean Dr.—assigned campaign #2; and

508 9^{th} Ave. N.—assigned campaign #3.

The campaign numbers correspond with each property address. A call comes in to the Realtor, a potential buyer phones in inquiring about 1421 Meadow Dr. The Realtor then contacts the input system using a telephone leaving the following voice mail as the input string, wherein the pre-determined triggers are underlined in capitol letters and the data is supplied in quotes:

“THIS IS “Realtor” I.D. NUMBER “555” CAMPAIGN NUMBER “1” DELIVER TO “Jimmy Sherwood” EMAIL ADDRESS “sherwoodjim@AOL.com” DELIVERY METHOD “online conference”, DELIVERY TELEPHONE NUMBER “409 555 1234” STATEMENT NUMBER “54” OPEN WITH “The first thing you mentioned to me was your love of the peace and quiet of a hot bath. This master bath allows you to soak all your troubles away . . . ” END OPENING STATEMENT. OVERVIEW “campaign number 1” BACKGROUND “number 5” END OF CALL”

The Client, in this case a realtor, then terminates the telephone call.

The voice mail is then reviewed by the reviewing system, in this case, a human being reviews the voice mail message wherein the user is authorized with the supplied I.D. number, the client is identified using the Campaign number along with the contact information to which the report is to be delivered.

The statement number trigger corresponds to a pre-recorded video file. For example, in real estate four primary sections may exist: 1. Marketing 2. Prospecting 3. CRM (customer relations management) and 4. Lead Management.

The Realtor opened with statement number 54, which in this instance is under the MARKETING section, which is slated in a Listing Response Category and is the pre-recorded voice of Realtor reciting the following dialogue: “Thank you for calling about this beautiful home. It has updated appliances and many wonderful features. You called with some specific questions, and I am more than happy to address those now”

Next, the reviewing system (a technician) combines statement number 54 with the data supplied by the user in the input string to produce the following report as an audio file in the Realtor's voice:

“Thank you for calling about this beautiful home. It has updated appliances and many wonderful features. You called with some specific questions, and I am more than happy to address those now, the first thing you mentioned to me was your love of the peace and quiet of a hot bath. This master bath allows you to soak all your troubles away . . . . ”

The trigger OPEN WITH have been pre-assigned to instruct the technician to splice the audio data contained in the input string and to use what he/she is saying in the presentation.

The trigger CAMPAIGN # and the number assigned to a person, product or both instructs the technician to display pre-recorded pictures of the property assigned to “campaign number 1” while the realtors voice is heard reciting the above script.

The trigger DELIVERY METHOD and the associated data “online conference” direct the reviewing system to deliver this report via online conference according to the email address or contact information of the prospective client.

The trigger GENRE STYLE direct the technician to include background music of a certain genre.

The trigger END OF CALL signifies the call is over and the report is to be generated.

### Example 2

In another example, a user:

1. makes a telephone call to the input system and inputs an input data string in the form of a voicemail.

2. the voicemail is recorded by the input system and stored on server connected to the internet.

3. the voicemail is reviewed by technician, who first saves the voicemail to a “Master Action” folder and then uses this voicemail triggers to prepare specified video clips based on the user ID number and the campaign number. In this example, the technician prepares a “numbered production sheet” within the Master Action folder, wherein the data input string is recorded in terms of the various triggers and the associated data.

4. Next, the technician associates the triggers and the data with the appropriate audio, video, picture, and text files as pre-determined according to the specifications of the user.

5. The associated files are then combined to produce the report, which may be a video presentation. The video is then reviewed for quality by the technician.

6. The report is distributed via the selected distribution method, which may include burning the report onto a DVD and delivering the DVD to the customer's physical addressor mailing the DVD. Distribution methods also include emailing the report, presenting the report in an online conference, or mailing the report on CD.

It should be understood, of course, that the foregoing relates to preferred embodiments of the invention and that modifications may be made without departing from the spirit and scope of the invention as set forth in the following claims.

We claim:

1. A method of generating a report comprising the steps of:
a) a user contacting an input receiving system;
b) the input receiving system receiving an input string from the user, wherein the input string comprises one or more pre-determined trigger words, trigger phrases, and/or trigger text;
c) the input receiving system storing the input string for future retrieval;
d) retrieving of the stored input string by a reviewing system;
e) reviewing of the stored input string by the reviewing system, wherein each of the trigger words, trigger phrases, and/or trigger text are each recognized by the reviewing system and are each associated with one or more pre-recorded audio files, image files, text files, and/or video files by the reviewing system;
f) combining the one or more associated pre-recorded audio files, image files, text files, and/or video files into a report; and
g) storing of the report for later retrieval.

2. The method of claim 1, further comprising the step of delivering the report to at least one intended recipient.

3. The method of claim 2, wherein the step of delivering the report includes the step of electronically transmitting the report over a network to the at least one intended recipient.

4. The method of claim 2, wherein the step of delivering the report includes the step of a telephonic audio delivery, an e-mail, a facsimile transmission, or a combination thereof.

5. The method of claim 2, wherein the step of delivering the report includes the step of recording the report onto portable media and physically distributing the portable media to an intended recipient.

6. The method of claim 1, further comprising the step of authenticating the user as being an authorized user.

7. The method of claim 1, wherein the string of one or more pre-determined trigger words, trigger phrases, and/or trigger text includes one or more trigger words, trigger phrases, and/or trigger text in which an audio file, an image file, a text file, and/or a video file is recorded as part of the input string, to produce one or more pre-recorded audio files, image files, text files, and/or video files, and wherein the one or more produced pre-recorded audio files, image files, text files, and/or video files are stored for subsequent retrieval.

8. The method of claim 1, wherein the string of one or more pre-determined trigger words, trigger phrases, and/or trigger text includes one or more trigger words, trigger phrases, and/or trigger text comprising a project identifier input, which identifies a particular project.

9. The method of claim 8, wherein the method further comprises incorporation of a pre-recorded opening statement, closing statement, or a combination thereof, triggered by the project identifier input.

10. The method of claim 1, wherein the input receiving system comprises one or more web-based applications capable of receiving an input string from the user.

11. The method of claim 10, wherein the input string received by one or more of the web-based applications includes text, check boxes, audio, video, universal resource locators, or a combination thereof.

12. The method of claim 1, wherein the method further comprises one or more quality control steps, wherein the quality of the report being generated is reviewed and passed on for further processing or returned to a previous step for modification, prior to the storing of the report for later retrieval.
